(19) United States
(12) Patent Application Publication
(10) Pub. No.: US 2007/0099743 A1
(43) Pub. Date: May 3, 2007

(54) Clutch assembly

(75) Inventor: Matthew John Reedman, Blackwood (AU)

Correspondence Address: WARN, HOFFMANN, MILLER & LALONE, .P.C, PO BOX 70098, ROCHESTER HILLS, MI, 48307, US

(73) Assignee: Schefenacker Vision Systems Austrialia Pty, Ltd

(21) Appl. No.: 10/580,281

(22) PCT Filed: Nov. 24, 2004
(86) PCT No.: PCT/AU04/01629

§ 371 Date: May 23, 2006

(30) Foreign Application Priority Data
Nov. 24, 2003 (AU) 2003906476

(51) Int. Cl. F16H 3/44

(52) U.S. Cl. 475/300

(57) ABSTRACT

A power-folding vehicle mirror assembly having an improved clutch assembly is disclosed. The assembly comprises: a base mountable to a vehicle; a clutch body mounted to and rotationally fixed to the base; a sun gear slidably mounted to the base for rotation, the sun gear biased towards engagement with the clutch body by a spring; a mirror head assembly rotatably mounted to the base; a planetary worm gear mounted to the mirror head assembly for rotation, the planetary gear meshing with the sun gear; and a motor for driving the mirror head assembly around the sun gear. Upon the application of a manual breakaway force to the mirror head assembly, the planetary gear transmits a breakaway torque to the sun gear. This causes the gear to slide away from and out of engagement with the clutch body, thereby allowing rotation of the sun gear and mirror head assembly with respect to the base while maintaining mesh with the worm gear. The clutch mechanism disclosed will have numerous other applications.

### FIELD OF THE INVENTION

The present invention relates to drive trains for transmitting rotational movement from a motor to a drive element. In particular, the invention relates to “overload” clutch assemblies within such drive trains.

### BACKGROUND

In many drive train applications overload relief is required. For instance, overload relief may be required to enable manual movement of a driven element without damaging the gear train Coupling and isolation between the overload protected side of a mechanism and the driven side of a mechanism can be provided by a positive engagement clutch. Such clutches are known and used in automotive applications including external mirror head drives. The applicant's patent PCT/AU02/00517 titled “POWER FOLD MECHANISM FOR DOUBLE ARM MIRRORS” discloses a clutch that is held in an engaged position by a spring force and is disengaged when the reaction forces at ramps on the clutch are great enough to overcome the spring force.

A problem with clutch mechanisms of the type employed in the power fold mechanism disclosed in PCT/AU02/00517 is that significant frictional force is generated between the splines and the clutch body resisting movement of the clutch body with respect to the splines.

It is an object of the present invention to ameliorate the aforementioned problem and to provide a simpler clutch assembly.

It is a further object of the invention to provide a clutch and reduction drive assembly of reduced complexity.

It is a further object of the invention to provide a power-folding vehicle mirror assembly having an improved clutch and reduction drive.

### SUMMARY OF THE INVENTION

According to a first aspect of the invention there is provided a power-folding vehicle mirror assembly comprising:
a base mountable to a vehicle;
a clutch body mounted to and rotationally fixed to the base;
a sun gear slidably mounted to the base for rotation about a first axis, the sun gear biased towards engagement with the clutch body by a biasing means;
a mirror head assembly rotatably mounted to the base;
a planetary gear mounted to the mirror head assembly for rotation about a second axis, the planetary gear meshing with the sun gear; and
a motor operably connected to the planetary gear for driving the mirror head assembly around the sun gear,
wherein, upon the application of a manual breakaway force to the mirror head assembly, the planetary gear transmits a breakaway torque to the sun gear, the breakaway torque sliding the sun gear away from and out of engagement with the clutch body, thereby allowing rotation of the sun gear and mirror head assembly with respect to the base while maintaining mesh with the planetary gear.

Preferably the biasing means comprises a spring.

Preferably the assembly further comprises ramped detents on the clutch body bearing against corresponding detents on the sun gear,
whereby the ramped detents enable an axial force to be generated as the detents are rotationally forced against each other, the axial force working against the spring to enable the sun gear to disengage from the clutch body thereby allowing relative rotation

Preferably the planetary gear is a worm gear.

Preferably the spring comprises a disc spring.

Preferably the spring has a negative spring rate.

Preferably the first and second axes are orthogonal, the sun gear is helically formed at a first helix angle and the worm gear is helically formed at a second helix angle complimentary to the first helix angle.

Preferably the ramped detents are ramped so that the breakaway torque is substantially the same in either breakaway direction.

According to a second aspect of the invention there is provided a clutch and reduction drive assembly comprising:
a first gear mounted to a first body for rotation about a first axis;
a second gear meshing with the first gear, the second gear mounted to a second body for rotation about a second axis; and
a clutch mechanism having a clutch body and a clutch body receiving portion, the receiving portion mounted to or integral with the second gear, the clutch mechanism preventing relative rotation between the clutch body and the second gear in an engaged position and allowing relative rotation between the clutch body and the second gear in a disengaged position,
characterised in that the clutch mechanism is disengagable by movement of the second gear together with the receiving portion with respect to both the clutch body and the first gear while the second gear remains meshing with the first gear, the movement in a direction along the second axis of rotation.

Preferably the clutch mechanism is loaded by a spring.

Preferably the dutch mechanism further comprises ramped detents on the clutch body bearing against corresponding detents on receiving portion,
whereby the ramped detents enable an axial force to be generated as the detents are rotationally forced against each other, the axial force overcoming the load on the clutch mechanism provided by the spring thereby enabling the clutch mechanism to disengage.

Preferably the first gear is a worm gear.

Preferably the worm gear is driven by a motor.

Preferably the motor drives the worm gear through a reduction gear drive.

Preferably the reduction gear drive includes a further worm gear.

Preferably the spring comprises a disc spring.

Preferably the spring has a negative spring rate.

Preferably second gear is helically cut at an angle to match the worm gear so as to allow the first and second axes of rotation to be perpendicular to each other. Alternatively, the second gear straight cut and the first and second axes of rotation are not perpendicular to each other. With this alternative, the movement of the second gear with respect to the clutch body in a direction along the second axis does not result in rotation of the second gear about the second axis.

The second aspect of the invention will find many applications. For instance an embodiment of the invention may include a vehicle sub-assembly such as an external mirror. With such an embodiment one of the first and second bodies would be connected to the vehicle body and the other of the first and second bodies would be connected to a driven component. For example, the driven component could be an externally mounted mirror head that is movable from a deployed position away from the vehicle side to a parked position adjacent the vehicle side under the action of the clutch and reduction drive assembly of the invention.

According to a third aspect of the invention there is provided a clutch and reduction drive assembly comprising:
a primary frame;
a clutch body mounted to and rotational fixed to the primary frame;
a primary gear slidably and rotatably mounted to the primary frame for rotation about a first axis, the primary gear biased towards engagement with the clutch body by a biasing means;
a secondary frame rotatably mounted to the base; and
a secondary gear mounted to the secondary frame for rotation about a second axis, the secondary gear meshing with the primary gear,
wherein the primary gear is movable against the biasing means from an engaged position in which rotation with respect to the clutch body is prevented to a disengaged position in which rotation with respect to the clutch body occurs.

Preferably the biasing means comprises a spring, still preferably, a disc spring.

Preferable the assembly further comprises ramped detents on the clutch body bearing against corresponding detents on the primary gear,
whereby the ramped detents enable an axial force to be generated as the detents are rotationally forced against each other, the axial force working against the spring to enable the primary gear to disengage from the clutch body thereby allowing relative rotation.

Preferably the secondary gear is a worm gear.

Preferably the spring has a negative spring rate.

Preferably the first and second axes are orthogonal, the primary gear is helically formed at a first helix angle and the worm gear is helically formed at a second helix angle complimentary to the first helix angle.

A specific embodiment of the invention will now be described in some further detail with reference to and as illustrated in the accompanying figures. This embodiment is illustrative, and is not meant to be restrictive of the scope of the invention.

### DETAILED DESCRIPTION OF PREFERRED EMBODIMENT OF THE INVENTION

A preferred embodiment of the invention is illustrated in the accompanying representations in which:

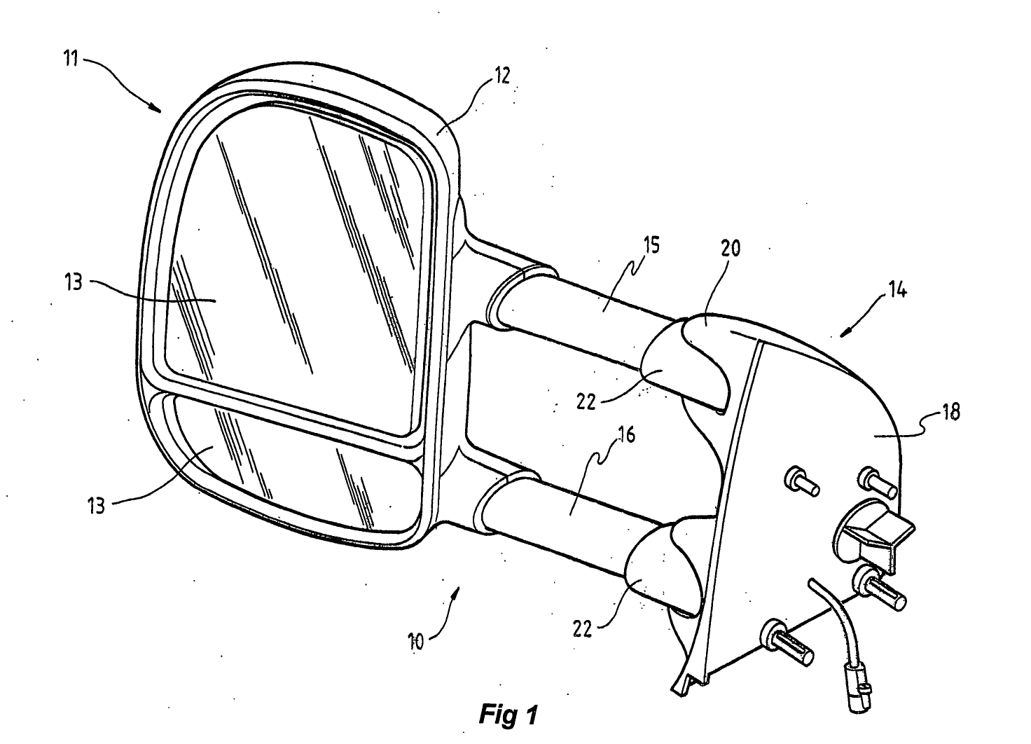

FIG. 1 shows a power folding external vehicle mirror assembly.

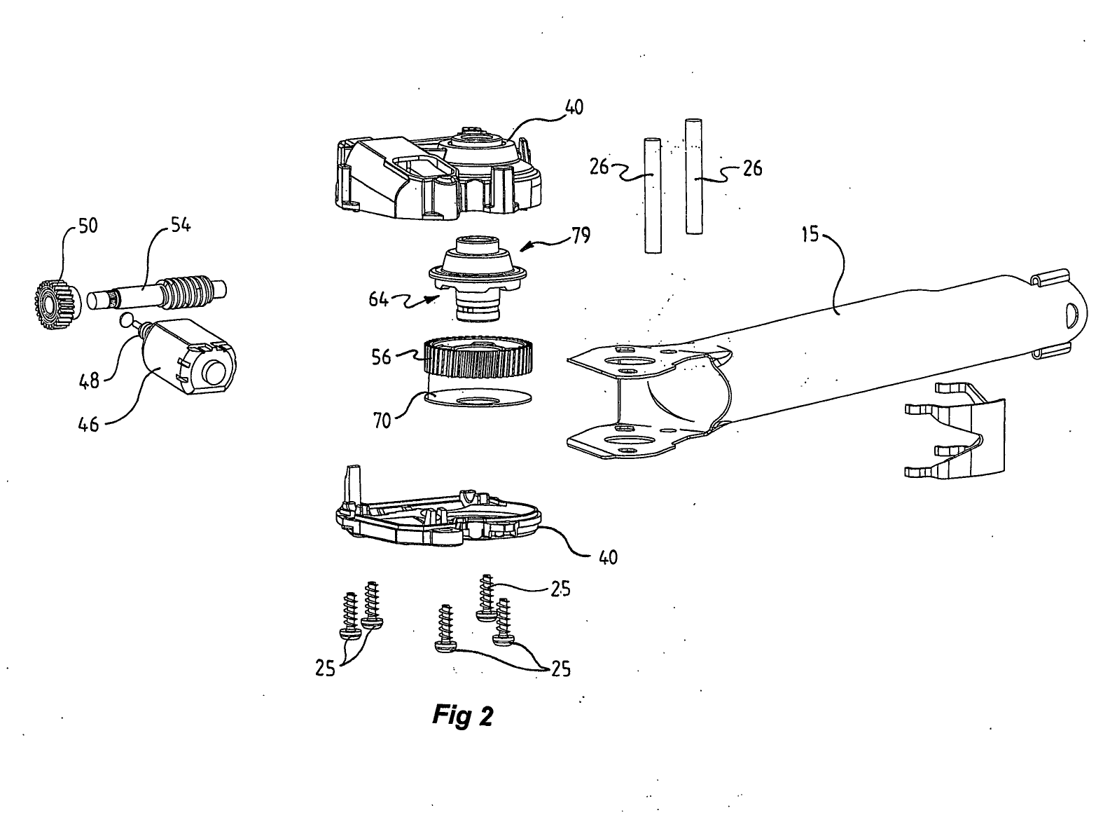

FIG. 2 is an exploded view of a power folding mechanism for a vehicle mirror.

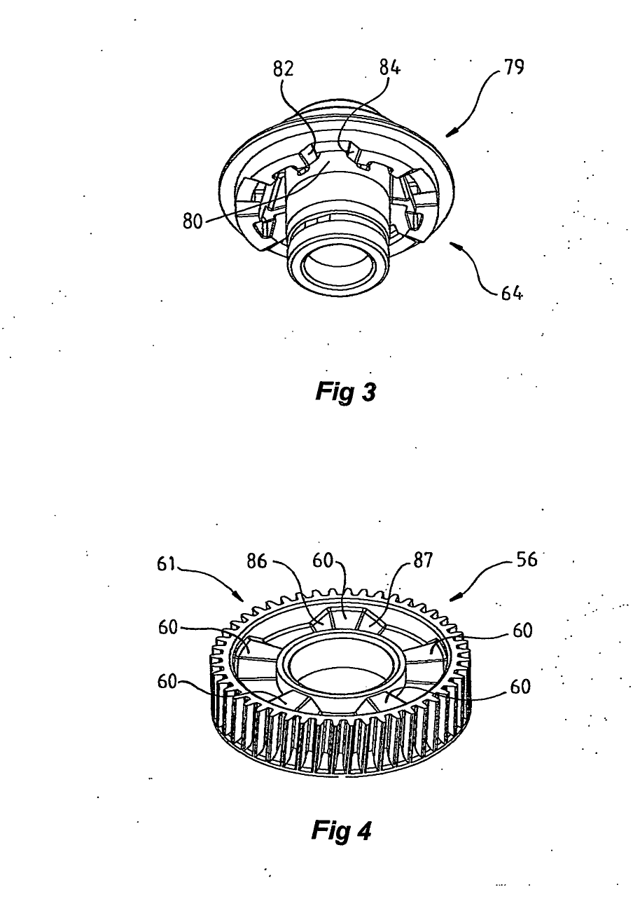

FIG. 3 is a perspective view of a clutch body component of the assembly of FIG. 2

FIG. 4 is a perspective view of a sun gear component of the assembly of FIG. 2.

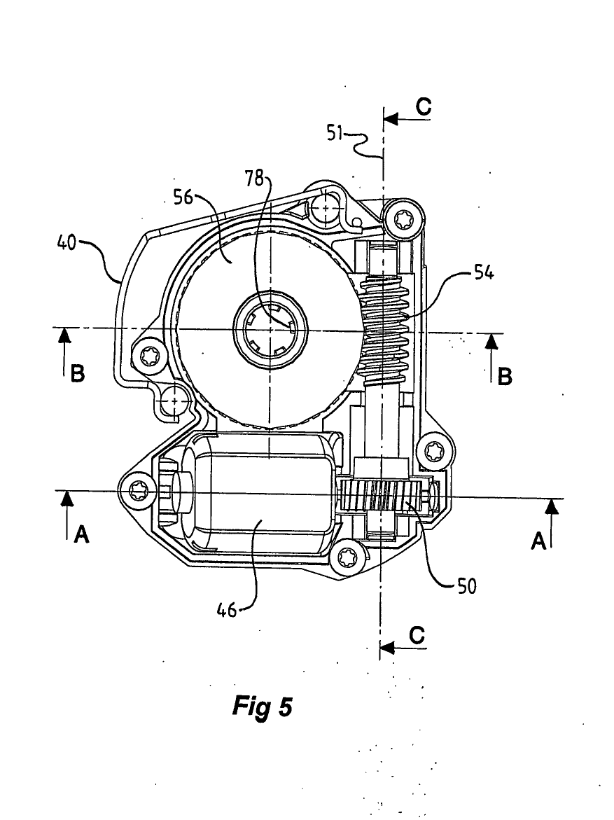

FIG. 5 is a front view of the assembly of FIG. 2.

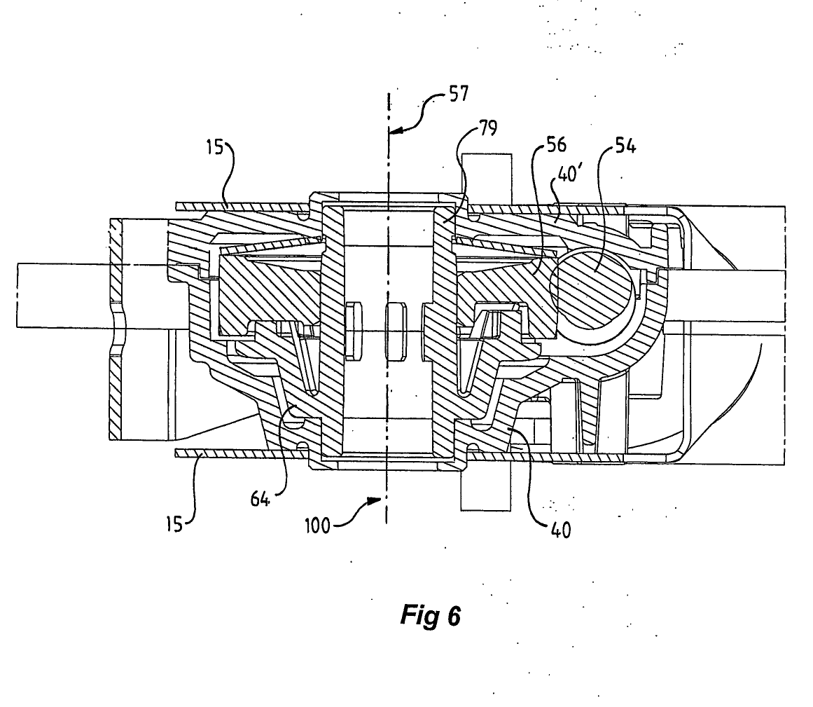

FIG. 6 is a sectionally view through the line B-B indicated on FIG. 5.

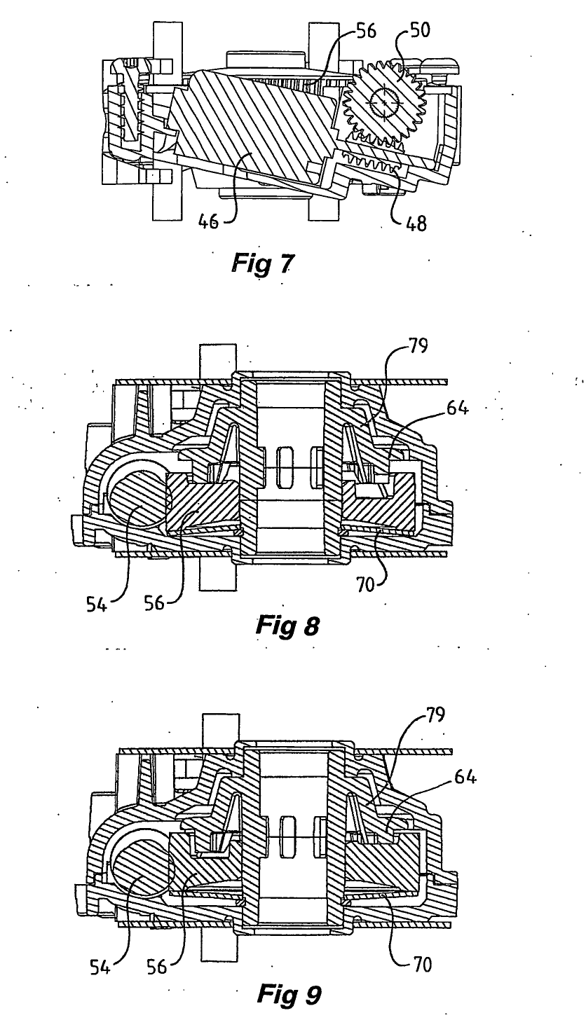

FIG. 7 is a sectional view through the line A-A as shown on FIG. 5.

FIGS. 8 and 9 are similar views to that of FIG. 6 (inverted) showing a disengaged and engaged position of a clutch mechanism respectively.

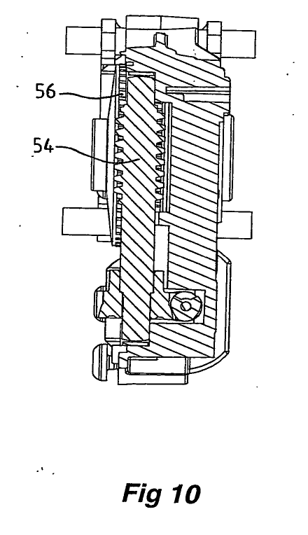

FIG. 10 is a sectional view through lines c as indicated on FIG. 5.

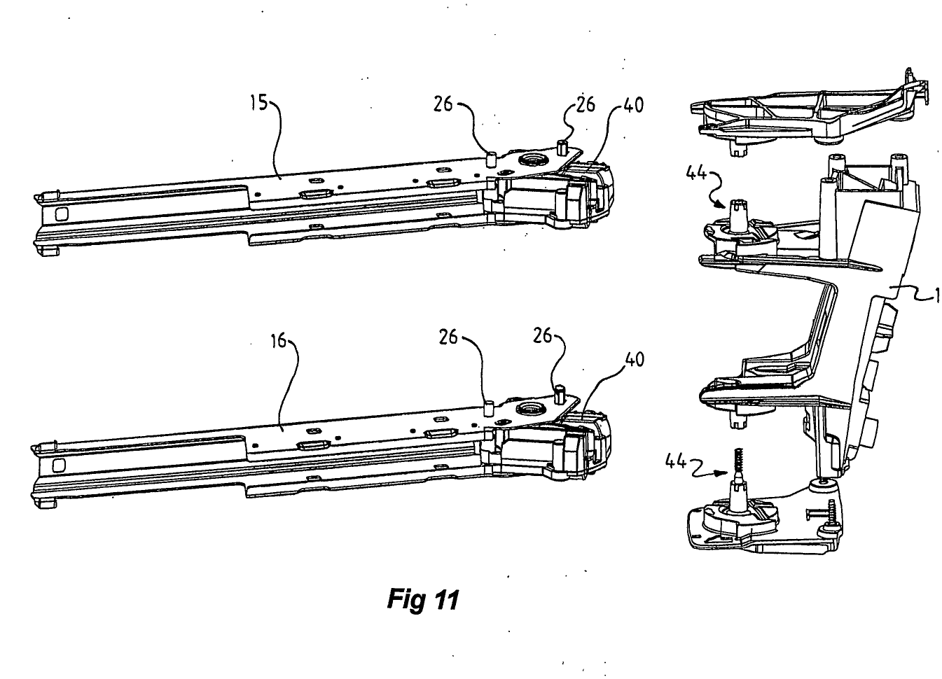

FIG. 11 is an exploded perspective view of the assembly of FIG. 1 with its covers removed.

Referring to FIGS. 2, 5 and 6, a clutch and reduction drive assembly according to an embodiment of the invention is shown. The clutch and reduction drive assembly comprises a first gear in the form of a drive worm 54 mounted to a first body in the form of a housing 40 for rotation about a first axis 51 (shown on FIG. 5). A second gear referred to hereinafter as a drive gear 56 meshes with the drive worm 54. The drive gear 56 is mounted to a second body by a part 79 for rotation about a second axis 57 as indicated on FIG. 6.

Depending on how the housing 40 and part 79 is mounted, rotation of the drive gear 56 about the second axis 57 may occur either when the clutch is engaged or disengaged.

The drive gear 56 has a dutch body receiving portion 61 integral with its upper face as is shown in FIG. 4. The receiving portion includes ramped detents 60 shaped to cooperate with a clutch body 64 which, in this embodiment, is integral with the part 79 as is shown in FIG. 3. The clutch mechanism prevents relative rotation between the clutch body 64 and the drive gear 56 in an engaged position and allows relative rotation between the clutch body 64 and the drive gear 56 in a disengaged position.

In other embodiments of the invention the receiving portion may be a separate component to the drive gear, and/or the dutch body may be a separate component to part 79.

The clutch mechanism is loaded by a spring arrangement in the form a disc spring 70 shown in FIGS. 2, 6, 8 and 9. This spring 70 biases the drive gear 56 upward into engagement with the clutch body 64. The ramped detents 60 enable an axial force to be generated as the detents are rotationally forced against each other. When the axial force is sufficient to overcome the load on the clutch provided by the spring 70, the clutch mechanism disengages thereby allowing the drive gear 56 to rotate with respect to the dutch body 64 and the part 79.

Referring to FIGS. 2 and 5 it can be seen that the clutch and reduction drive assembly is driven by an electric motor 46 driving the motor worm 48 which in turn drives a motor worm driven gear 50 which is fixed to the drive worm 54. The drive worm 54 meshes with the drive gear 56.

With this embodiment of the invention, the second gear, that is the drive gear 56 is helically cut at an angle to match the worm gear 54 so as to allow the first and second axis of rotation 51 and 57 to be perpendicular to each other. With this arrangement, the drive gear 56 will advance or retard with respect to the drive worm 54 (depending on the hand of the worm) as the clutch is moved from an engaged to a disengaged position. To maintain equal disengagement torque in either rotational directions, different ramp angles on the faces of the detents 60 are used. For example, referring to FIGS. 3 and 4, ramps 86 and 87 are different angles, as are ramps 82 and 84 on the clutch body 64.

In an alternative embodiment of the invention the drive gear 56 is straight cut and the first and second axes of rotation 51 and 57 are not perpendicular to each other. With this alternative arrangement, no advancing or retarding of the drive gear occurs, however more space is required to accommodate the drive components.

The disc or belleville spring 70 can be replaced with a conventional coil spring or any other biasing arrangement.

With the clutch assembly described above, there is no requirement for a spline on the axially moving component, in this case gear 56. The meshing between the teeth of the gear 56 and the gear 54 replaces the need for a spline. Not only does this simplify the construction of the dutch mechanism as compared to earlier clutches, it results in a significant reduction in the frictional force that usually exists between the splined components.

The clutch and reduction drive assembly described above will have many applications. In automotive components such as mirrors there is a need to provide motor driven components with the ability to be manually overridden without damage of a gear train. A particular example of this is a power folding truck “wing” mirror illustrated in FIG. 1.

FIG. 1 shows an external side or “wing” mirror assembly 11 comprising a mirror head assembly 12 and two mirrors 13. The mirror assembly 11 has a base 14 mountable to a vehicle. As shown in FIG. 11, upper and lower arms 15 and 16 extend from the base 14 to the head portion 12. Each arm 15 and 16 has a clutch and reduction drive assembly mounted within a housing comprising upper and lower shells 40 and 40′ as shown in FIG. 2. Screws 25 hold the housing shells together. The housing and hence the clutch and reduction drive assembly is mounted into the arms by means of two press fit pins 26 through the housing 40 as shown in FIGS. 2 and 11. Referring now to FIG. 11, it can be seen that the clutch and reduction drive assembly is mounted to the base assembly 14 by a spigot 44 that penetrates up through the part 79. Part 79 is keyed to prevent rotation with respect to spigot 44. The keys 78 are shown in FIG. 5.

As can be seen in the sectional view of FIG. 6 (taken through section lines B-B indicated in FIG. 5) the housing 40 (having a lower portion 40′) is securely held within mirror arm 15. Thus the axis 51 about which the drive worm 54 rotates is fixed with respect to the mirror arm 15 and the head assembly 12. Therefore, while the clutch remains engaged, rotation of the drive worm 54 causes the housing 40 and the mirror arm 15 and head portion 12 to rotate about the drive gear axis 57. The drive worm 54 can be considered a planetary gear as it drives around the axis 57 shown in FIG. 6. The gear 56, referred to previously as drive gear 56, will now be referred to as sun gear 56 as it is the gear about which the planetary worm gear 54 rotates as the motor 46 drives the worm gear 54.

Importantly, the sun gear 56 is slideably mounted to the base 14 and is slideably movable from the position shown in FIG. 9 downwards to the position shown in FIG. 8. A biasing means in the form of a disc spring 70 biases the sun gear 56 upwards into engagement with the clutch body 64 as is illustrated in FIG. 9. It is only where a manual breakaway force is applied to the mirror head assembly 12, for instance by a person manually pressing against the mirror head to park it or by the mirror head impacting on a person or a fixed object, that the clutch mechanism releases to the position shown in FIG. 8. Release occurs upon the application of a manual breakaway force to the mirror head because the planetary worm gear 54 transmits the breakaway torque to the sun gear 56, the breakaway torque sliding the sun gear 56 away from an outer engagement with the clutch body 56. This occurs while maintaining mesh with the planetary gear.

Arm covers or shrouds 22 enclose the assembly 17 to protect it and provide an aesthetically pleasing appearance as shown in FIG. 1.

With the embodiment of the invention described above with reference to FIGS. 1 to 11, a pair of arms 15 and 16 are provided between the base 14 and the mirror head assembly 12. In other embodiments, distinct arms will not be present. The mirror head assembly will be directly mounted to the base for relative rotation thereto.

The mirror assembly 11 shown in FIG. 1 may have a telescopically adjustable head assembly 12. The above described invention may equally be applied to a mirror assembly 11 with or without telescopically adjustable head 12.

Many other applications for the clutch and reduction drive assembly 17 described above will exist. In some applications, the first gear may not be a drive worm 54 but instead may be a spur or helically cut gear 54 (not shown). In applications where no reduction is required and only clutching is required, the first gear may have the same pitch circle diameter as the second gear (the drive gear 56).

In the embodiments described above, drive input is through the first gear (the worm 54) with rotation of the housing 40 about the axis 100 of spigot 44 comprising the output. The axis of rotation 100 is illustrated in FIG. 7. In other embodiments the drive may be reversed with the worm 54 replaced by an output helical or spur gear and input being provided by rotation of the spigot 44 and hence the clutch body 64 about the axis 100.

While the present invention has been described in terms of a preferred embodiment, in order to facilitate better understanding of the invention, it should be appreciated that various modifications can be made without departing from the principles of the invention. Therefore, the invention should be understood to include all such modifications within its scope.

1. A power-folding vehicle mirror assembly comprising:
a base mountable to a vehicle;
a clutch body mounted to and rotationally fixed to the base;
a sun gear slidably mounted to the base for rotation about a first axis, the sun gear biased towards engagement with the clutch body by a biasing means;
a mirror head assembly rotatably mounted to the base;
a planetary gear mounted to the mirror head assembly for rotation about a second axis, the planetary gear meshing with the sun gear; and
a motor operably connected to the planetary gear for driving the mirror head assembly around the sun gear,
wherein, upon the application of a manual breakaway force to the mirror head assembly, the planetary gear transmits a breakaway torque to the sun gear, the breakaway torque sliding the sun gear away from and out of engagement with the clutch body, thereby allowing rotation of the sun gear and mirror head assembly with respect to the base while maintaining mesh with the planetary gear.

2. An assembly as claimed in claim 1 wherein the biasing means comprises a spring.

3. An assembly as claimed in claim 2 further comprising ramped detents on the clutch body bearing against corresponding detents on the sun gear,
whereby the ramped detents enable an axial force to be generated as the detents are rotationally forced against each other, the axial force working against the spring to enable the sun gear to disengage from the clutch body thereby allowing relative rotation.

4. An assembly as claimed in claim 3 wherein the planetary gear is a worm gear.

5. An assembly as claimed in claim 4 wherein the spring comprises a disc spring.

6. An assembly as claimed in claim 5 wherein the spring has a negative spring rate.

7. An assembly as claimed in claim 6 wherein the first and second axes are orthogonal, the sun gear is helically formed at a first helix angle and the worm gear is helically formed at a second helix angle complimentary to the first helix angle.

8. An assembly as claimed in claim 7 wherein the ramped detents are ramped so that the breakaway torque is substantially the same in either breakaway direction.

9. An assembly as claimed in claim 8 wherein the mirror head assembly comprises:
an arm having a proximal end rotatably mounted to the base and a distal end remote from the base;
a head mounted to the distal end of the arm; and
a mirror mounted to the head.

10. An assembly as claimed in claim 9 wherein the planetary gear and motor are housed within the arm.

11. A clutch and reduction drive assembly comprising:
a first gear mounted to a first body for rotation about a first axis;
a second gear meshing with the first gear, the second gear mounted to a second body for rotation about a second axis; and
a clutch mechanism having a clutch body and a clutch body receiving portion, the receiving portion mounted to or integral with the second gear, the clutch mechanism preventing relative rotation between the clutch body and the second gear in an engaged position and allowing relative rotation between the clutch body and the second gear in a disengaged position,
wherein the clutch mechanism is disengagable by movement of the second gear together with the receiving portion with respect to both the clutch body and the first gear while the second gear remains meshing with the first gear, the movement in a direction along the second axis of rotation.

12. An assembly as claimed in claim 11 wherein the clutch mechanism is loaded by a spring.

13. An assembly as claimed in claim 12 wherein the clutch mechanism further comprises ramped detents on the clutch body bearing against corresponding detents on receiving portion,
whereby the ramped detents enable an axial force to be generated as the detents are rotationally forced against each other, the axial force overcoming the load on the clutch mechanism provided by the spring thereby enabling the clutch mechanism to disengage.

14. An assembly as claimed in claim 13 wherein the first gear is a worm gear.

15. An assembly as claimed in claim 14 wherein the worm gear is driven by a motor.

16. An assembly as claimed in claim 15 wherein the motor drives the worm gear through a reduction gear drive.

17. An assembly as claimed in claim 16 wherein the reduction gear drive includes a further worm gear.

18. An assembly as claimed in claim 17 wherein the spring comprises a disc spring.

19. An assembly as claimed in claim 18 wherein the spring has a negative spring rate.

20. A clutch and reduction drive assembly comprising:
a primary frame;
a clutch body mounted to and rotational fixed to the primary frame;
a primary gear slidably and rotatably mounted to the primary frame for rotation about a first axis, the primary gear biased towards engagement with the clutch body by a biasing means;
a secondary frame rotatably mounted to the base; and
a secondary gear mounted to the secondary frame for rotation about a second axis, the secondary gear meshing with the primary gear,
wherein the primary gear is movable against the biasing means from an engaged position in which rotation with respect to the clutch body is prevented to a disengaged position in which rotation with respect to the clutch body occurs.

21. An assembly as claimed in claim 20 wherein the biasing means comprises a spring.

22. An assembly as claimed in claim 21 further comprising ramped detents on the clutch body bearing against corresponding detents on the primary gear,
whereby the ramped detents enable an axial force to be generated as the detents are rotationally forced against each other, the axial force working against the spring to enable the primary gear to disengage from the clutch body thereby allowing relative rotation.

23. An assembly as claimed in claim 22 wherein the secondary gear is a worm gear.

24. An assembly as claimed in claim 23 wherein the spring comprises a disc spring.

25. An assembly as claimed in claim 24 wherein the spring has a negative spring rate.

26. An assembly as claimed in claim 25 wherein the first and second axes are orthogonal, the primary gear is helically formed at a first helix angle and the worm gear is helically formed at a second helix angle complimentary to the first helix angle.

27. A power-folding vehicle mirror assembly substantially as hereinbefore described with reference to and as illustrated in the accompanying drawings.
